(19) United States
(12) Patent Application Publication
(10) Pub. No.: US 2024/0281692 A1
(43) Pub. Date: Aug. 22, 2024

(54) TEMPORAL AND SFQ PULSE STREAM ENCODING FOR AREA EFFICIENT SUPERCONDUCTING ACCELERATORS

(71) Applicant: THE REGENTS OF THE UNIVERSITY OF CALIFORNIA, Oakland, CA (US)

(72) Inventors: Luisa Patricia Gonzalez-Guerrero, Naperville, IL (US); Georgios Michelogiannakis, Berkeley, CA (US); Meriam Gay Bautista, Katy, TX (US); Darren Lyles, San Ramon, CA (US)

(21) Appl. No.: 18/583,530

(22) Filed: Feb. 21, 2024

Related U.S. Application Data
(60) Provisional application No. 63/486,112, filed on Feb. 21, 2023.

(51) Int. Cl. G06N 10/40

(52) U.S. Cl. CPC G06N 10/40

(57) ABSTRACT

A superconducting computing architecture includes at least one computing element including a first input to receive a first set of electrical pulses encoded in a first data representation, a second input to receive a second set of electrical pulses encoded in a second data representation, and an operator to perform an operation and generate an output based on the first input and the second input.

### CROSS-REFERENCE TO RELATED APPLICATIONS

This application claims the benefit of U.S. Provisional Patent Application No. 63/486,112, filed on Feb. 21, 2023, the entire contents of which is hereby incorporated by reference herein.

### STATEMENT OF GOVERNMENT SUPPORT

This invention was made with government support under Contract No. DE-AC02-05CH11231 awarded by the U.S. Department of Energy. The government has certain rights in this invention.

### FIELD

The present invention relates to the superconducting logic circuit design and more particularly, relates to temporal and single flux quantum pulse stream encoding for superconducting logic circuit design.

### BACKGROUND

Superconductivity is the phenomenon wherein the electrical resistance of a material approaches zero as it is cooled to below a critical temperature. Computing with such superconducting materials continues to be the subject of research.

### BRIEF DESCRIPTION OF THE DRAWINGS

FIG. 1 illustrates example an example SQUID for SFQ pulse logic built from JJs, according to one embodiment.

FIG. 2 illustrates example components of an RSFQ circuitry, according to one embodiment.

FIG. 3A illustrates an example race logic operation, according to some embodiments.

FIG. 3B illustrates an example race logic data representation for unipolar and bipolar schemes, according to one embodiment.

FIG. 4 illustrates an example of pulse arithmetic within a pulse stream logic scheme, according to one embodiment.

FIG. 5A illustrates a unipolar SFQ multiplier, according to one embodiment.

FIG. 5B illustrates a bipolar SFQ multiplier, according to one embodiment.

FIG. 5C illustrates two examples of SFQ unary multiplication, according to one embodiment.

FIG. 6A illustrates a comparison of latency of a proposed SFQ unary multiplier compared to a binary multiplier, according to one embodiment.

FIG. 6B illustrates a comparison of area consumption of a proposed SFQ unary multiplier compared to a binary multiplier, according to one embodiment.

FIG. 6C illustrates a power consumption of a proposed multiplier, according to one embodiment.

FIG. 7 illustrates an example circuit for a SFQ unary adder by merger, according to one embodiment.

FIG. 8A illustrates an example 2:2 balancer component, according to one embodiment.

FIG. 8B illustrates an example balancer output stage, according to one embodiment.

FIG. 8C illustrates a Mealey machine of a balancer routing logic, according to one embodiment.

FIG. 8D illustrates a 4:1 counting network, according to one embodiment.

FIG. 8E illustrates a B-Flip Flop (BFF), according to one embodiment.

FIG. 8F illustrates a balancer routing unit, according to one embodiment.

FIG. 9 illustrates example balancer input and output waveforms, according to one embodiment.

FIG. 10A illustrates a comparison of latency for unary SFQ and binary adders, according to one embodiment.

FIG. 10B illustrates a comparison of area consumption for unary SFQ and binary adders, according to one embodiment.

FIG. 11A illustrates a pulse number multiplier (PNM), according to one embodiment.

FIG. 11B illustrates a pulse number multiplier (PNM) using TFF2s to generate a stream resembling a uniform rate, according to one embodiment.

FIG. 12A illustrates a race logic shift register using SFQ DFFs, according to one embodiment.

FIG. 12B illustrates an example of a conceptual integrator-based race logic buffer using an inductance to accumulate SFQ pulses, according to one embodiment.

FIG. 12C illustrates SFQ control logic for an integrator-based buffer, according to one embodiment.

FIG. 12D illustrates a memory cell based on a race logic buffer, according to one embodiment.

FIG. 13 illustrates simulated waveforms for inputs and outputs of a proposed race logic buffer, according to one embodiment.

FIG. 14 illustrates an area consumption of various shift registers, according to some embodiments.

FIG. 15A illustrates an example of a unipolar processing element consisting of a multiplier, adder, and integrator, according to one embodiment.

FIG. 15B illustrates an example of an array of processing elements in a hardware accelerator, according to one embodiment.

FIG. 16A illustrates a comparison of latency of a processing unit using unary logic and a processing unit using binary logic, according to one embodiment.

FIG. 16B illustrates a comparison of area consumption of a processing unit using unary logic and a processing unit using binary logic, according to one embodiment.

FIG. 17 illustrates an example unary SFQ dot product unit, according to one embodiment.

FIG. 18 illustrates a comparison of the area consumption of a unary dot product unit and a binary dot produce unit, according to some embodiments.

FIG. 19 illustrates an example of a unary SFQ finite impulse response filter (FIR), according to some embodiments.

FIG. 20A illustrates a comparison of latency for a unary SFQ and binary SFQ finite impulse response filter, according to some embodiments.

FIG. 20B illustrates a comparison of throughput for a unary SFQ and binary SFQ finite impulse response filter, according to some embodiments.

FIG. 20C illustrates a comparison of area consumption for a unary SFQ and binary SFQ finite impulse response filter, according to some embodiments.

FIG. 20D illustrates a comparison of efficiency for a unary SFQ and binary SFQ finite impulse response filter, according to some embodiments.

FIG. 21A illustrates a signal to noise ratio against an error rate for a unary SFQ finite impulse response filter, according to some embodiments.

FIG. 21B illustrates an error distribution for a unary SFQ finite impulse response filter with one percent of errors, according to some embodiments.

FIG. 21C illustrates the effect of errors in the frequency response for a unary SFQ finite impulse response filter, according to some embodiments.

FIG. 22A illustrates a percentage improvement in latency for a unary SFQ finite impulse response filter over a WP binary finite impulse response filter, according to some embodiments.

FIG. 22B illustrates a percentage improvement in area consumption for a unary SFQ finite impulse response filter over a WP binary finite impulse response filter, according to some embodiments.

FIG. 22C illustrates a percentage improvement in efficiency for a unary SFQ finite impulse response filter over a WP binary finite impulse response filter, according to some embodiments.

### DETAILED DESCRIPTION

Metals are known to be good electrical conductors. Certain metals additionally exhibit zero electric resistance at low temperatures, making them superconductors at low temperatures. Superconductivity is the property of certain metals to have zero resistance below a critical temperature, usually a few degrees Kelvin. While in the semiconductor realm, the metal-oxide-semiconductor field-effect transistor (MOSFET) and the complimentary metal-oxide-semiconductor (CMOS) logic family have dominated digital design, in superconductors, the Josephson junction (JJ), an ultra-fast switching device, and the Rapid-Single-Flux-Quantum (RSFQ) logic family have been the most popular approach. In RSFQ, a logic transition is represented as pico-seconds-wide, tens-of-millivolts-amplitude pulse which enables processing speeds of tens of Giga-Hertz (GHz) while keeping the switching energy six orders of magnitude less than current CMOS processes.

A JJ may be made by sandwiching a thin layer of non-superconducting material—an electronic barrier—between two layers of superconducting material. JJs may be capable of ultrafast (as low as 1 ps), low-energy (to the order of 10⁻¹⁹ J) switching by exploiting the Josephson effect: electron pairs tunnel through the barrier without any resistance up to a critical current. At the critical threshold, a JJ switches from its superconducting state to a resistive one and exhibits an electronic “kickback” in the form of magnetic quantum flux transfer—observable as a voltage pulse on the output. To enable stateful circuit operation, the unit of flux can be temporarily stored in a composite device known as the superconducting quantum interference device (SQUID), which is built as a superconducting loop interrupted by two serial JJs and is common to many superconducting circuits.

Typical superconducting architectures implement logic using CMOS-inspired data representation, predominantly with AND-OR logic. Because in RSFQ AND-OR gates are synchronous, RSFQ logic circuits today often use deeply-pipelined datapaths where almost every cell in the design must be synchronized with a global clock. These deeply-pipelined structures suffer from control and data hazards and stringent timing constraints that result in expensive clock trees. Besides architectural challenges, manufacturing limitations restrict the number of active devices to just a few tens of thousands of JJs per die. Thus, superconducting circuits have been limited to relatively low scales. Unary computing is a promising solution to improve the area and energy efficiency of massively-parallel computing. In CMOS unary computing, a number is represented as a stream of high and low voltages, enabling computing with a very low area footprint. Some typical examples of CMOS unary computing are Synchronous Stochastic Computing (SSC) and Race Logic (RL). Other more exotic flavors include asynchronous stochastic computing and computing with 24-Modulated or Pulse-Width-Modulated streams. A typical CMOS SSC multiplier is implemented as a simple AND gate. Calculating the minimum between two values in RL requires a single OR gate, yielding area savings of more than 90% compared to calculating the minimum of two binary values.

Conventional unary approaches such as SSC and RL in SFQ technology, demonstrate beneficial trade-offs between area and energy/power consumption for selected applications. Stream-based methods, such as SSC, are particularly efficient for mathematical operations yet sacrifice accuracy to latency. On the other hand, RL yields area efficiency for dynamic programming algorithms, yet it is expensive for arithmetic computations such as multiplication and addition.

Single flux quantum (SFQ) power consumption can be divided into three major components: i) active due to switching, which is proportional to the number of JJs and the activity factor; ii) passive due to biasing of the JJs; and iii) cooling power. Although RSFQ is the pioneer and most popular logic family, it suffers from high passive power consumption due to using resistors for biasing which results in a constant current draw. To address this, logic families such as energy-efficient RSFQ (ERSFQ) replace biasing resistors for a network of JJs eliminating the passive power consumption at the expense of a slight increment in the area. With ERSFQ, the performance per W of superconducting designs can be 493× higher than CMOS implementation without cooling costs associated with superconducting and 1.23× higher than a CMOS implementation with the cooling costs associated with superconducting. Moreover, ongoing work in cryocooling fostered by the advancement of cryo-sensors and quantum computing is likely to further increase the energy and power savings of SFQ compared with CMOS. Given that previous work has demonstrated the potential for superconducting circuits for better throughput and energy efficiency, the present disclosure illustrates the additional benefits of embodiments of a U-SFQ architecture over binary SFQ architectures.

Superconducting technology has the potential to address the current challenges of high-performance computing. However, the following limitations hinder wider-spread adoption of superconducting digital computing: (1) Limited device density: There is a 1000× device density gap between superconducting technology and CMOS. This limited device density is exacerbated by the fact that SFQ logic requires more devices to implement traditional binary designs than CMOS. (2) Reliability: JJs are susceptible to flux-trapping and manufacturing defects. This results in a fault mode that is significantly different than CMOS. Architecture-level solutions such as redundancy have been proposed, exacerbating the device density limitations mentioned before. Another option is the development of appropriate EDA tools that include these fault modes in the synthesis and P&R flow. (3) Memory: Although cryogenic memories such as (i) Vortex-Transition-Memory (VTM), (ii) Josephson-CMOS static random-access memory (SRAM), (iii) Magnetic RAM (MRAM), and (iv) superconducting nanowire RAM (SNM) have been proposed, there are still density, integration and performance limitations to be addressed. For practical reasons the most viable on-chip memory for SFQ technologies uses DFF-based shift registers. (4) EDA tools: have been developed as part of academic research efforts mostly focused on device and gate level simple synthesis that reaches thousands of gates. To achieve large scale integration capable of reaching billions of active devices, tools that enable back-annotation from the layout to schematic, and parameter extraction are still required.

Embodiments of the present disclosure address the challenges of conventional and prior approaches by providing a wave-pipelined Unary SFQ (U-SFQ) architecture. In particular, embodiments provide a combination of beneficial aspects of computing with pulse streams and RL, leveraging SFQ pulses as an efficient form of data representation.

In some embodiments, the wave-pipelined U-SFQ architecture extends RL to make it suitable for arithmetic operations and defines SFQ pulse stream characteristics for efficient computing. Building blocks for the U-SFQ include components such as multipliers, adders, and memory elements for unary SFQ data representation. In some embodiments, the U-SFQ building blocks are combined to provide a processing element (PE) for Coarse-Grained Reconfigurable Architectures (CGRAs) or Spatial Architectures (SpA) for convolutional neural networks (CNNs). Additionally, in some embodiments the U-SFQ building blocks are combined to create a dot-product unit (DPU), which is a basic building block of artificial neural networks and Digital Signal Processing (DSP). Furthermore, the U-SFQ building blocks may be combined to provide a programmable Finite Impulse Response (FIR) filter accelerator. FIR filters are one of the most used DSP hardware accelerators but also demand a high number of hardware resources given the high number of additions and multiplications. While multipliers, adders, and memory elements are described as the basic U-SFQ building blocks, any foundational logic elements may be implemented using the U-SFQ architecture described herein. Similarly, while a PE, DPU and FIR filter accelerator are described for hardware accelerators, the U-SFQ building blocks may be combined in any manner to generate any other type of circuit.

Embodiments of the U-SFQ processing elements may yield up to 200× savings in area (number of JJs) compared to their binary counterparts. This results in 28%-98% savings in area for a U-SFQ PE array compared with its binary counterpart for the same throughput. Moreover, the described U-SFQ architecture is resilient to computing errors. In binary, a 30% error rate results in +30 dB of signal to noise ratio (SNR) degradation, versus only 4 dB for embodiments of the U-SFQ architecture described herein.

In some embodiments, a superconducting computing architecture including a first computing element with a first input to receive a first set of electrical pulses encoded in a first data representation, a second input to receive a second set of electrical pulses encoded in a second data representation and an operator to perform an operation and generate an output based on the first input and the second input. In some embodiments, the first computing element includes a unary multiplier, where the first data representation includes a pulse rate of an SFQ pulse stream and the second data representation includes a temporal Race Logic signal.

In some embodiments, the first computing element comprises a unary adder using a merger, where the first data representation and the second data representation each include a pulse rate of an SFQ pulse stream. In some embodiments, the first computing element includes a unary adder using at least one balancer, wherein the first data representation and the second data representation each include a pulse rate of an SFQ pulse stream. In some embodiments, the first computing element comprises a memory bank implemented as a pulse number multiplier using dual-port toggle flip flops. In some embodiments, the first computing element includes a Race Logic shift register implemented using at least one inductor to integrate pulses from a clock source.

In some embodiments, the processing element includes at least the first computing element. In some embodiments, the processing element includes at least one of a unary multiplier, a unary adder, or an accumulator implemented using the first data representation and the second data representation. In some embodiments, a plurality of processing elements are arranged in an array of processing elements.

In some embodiments, a dot product unit includes at least the first computing element. In some embodiments, the dot product unit includes a plurality of unary multipliers arranged in parallel and a counting network.

In some embodiments, a finite impulse response filter includes at least the first computing element. In some embodiments, the finite impulse response filter includes at least one of a unary dot product unit, a unary adder, or a unary shift register to operate as a delay element.

Superconducting technology is a prime candidate for the future of computing. However, current superconducting prototypes are limited to small-scale examples due to stringent area constraints and complex architectures inspired from voltage-level encoding in CMOS; this is at odds with the ps-wide Single Quantum Flux (SFQ) pulses used in superconductors to carry information.

Embodiments described herein provideawave-pipelined Unary SFQ (U-SFQ) architecture that leverages the advantages of two data representations: pulse-streams and Race Logic (RL). In particular, novel building blocks such as multipliers, adders, and memory cells, are described which leverage the natural properties of SFQ pulses to mitigate area constraints. Additionally, the U-SFQ building blocks described, also referred to as computing elements, are used to implement three hardware accelerators: i) a Processing Element (PE), typically used in spatial architectures; ii) A dot-product-unit (DPU), one of the most popular accelerators in artificial neural networks and digital signal processing (DSP); and iii) A Finite Impulse Response (FIR) filter, a popular and computationally demanding DSP accelerator. The U-SFQ building blocks described herein require up to 200× fewer JJs compared to their SFQ binary counterparts, exposing an area-delay trade-off. Accordingly, embodiments described herein mitigate the stringent area constraints of superconducting technology.

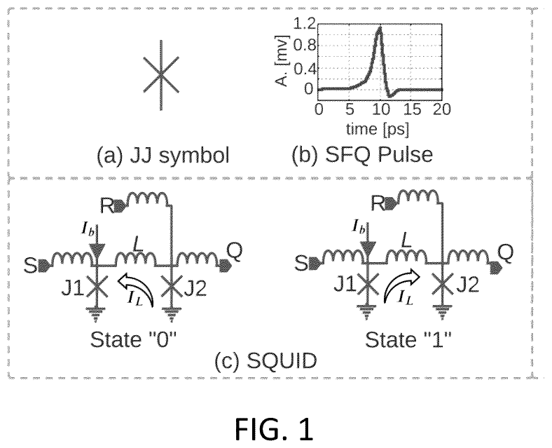

FIG. 1 illustrates the primary components of superconducting circuits, according to some embodiments. Superconductors are metals with zero resistance below critical temperatures. The main element used for superconducting circuits is the JJ (a) that allows current through with no resistance until a critical current (Ic). Reaching Ic causes the JJ to switch to a resistive state and emit a pico-second (ps) wide voltage pulse (e.g., SFQ pulse (b)).

An additional basic building block for RSFQ logic is the Superconducting Quantum Interference Device (SQUID). The SQUID (c) is built using two JJs (J1,J2) connected by an inductance (L), and has two stable stationary states that differ by the direction of the persistent current (I_{L}) circulating in the loop. Assume that I_{L} circulates counterclockwise so that the current in J1=I_{b}/2+I_{L}≈0.7I_{c}, where I_{b} the bias current. This state represents a zero. If an SFQ pulse arrives at input S, the current through J1 reaches its critical current, provoking a quick superconducting→resistive→superconductive transition (also known as a kickback), and the direction of I_{L} becomes clockwise. A clockwise current direction represents a “1”. Now, if an SFQ pulse occurs at input port R, the current through J2 reaches its critical current and the cell reverts to a state “0”. This fast kickback generates an SFQ pulse at J2, which will be propagated at output Q.

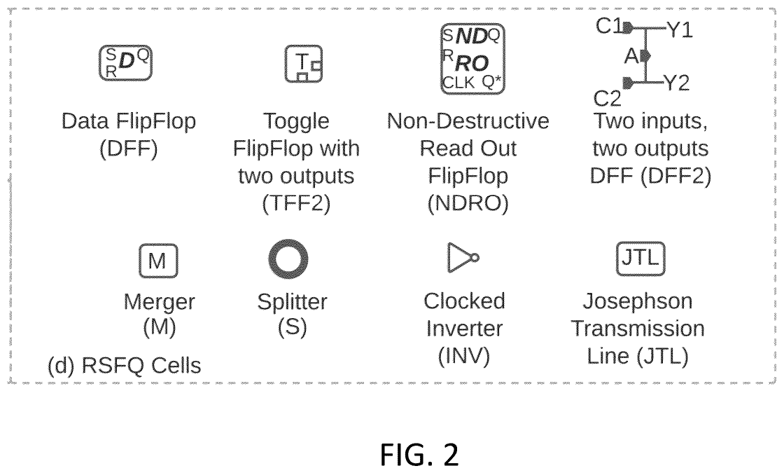

FIG. 2 depicts example components of RSFQ logic including RSFQ logic gates, according to some embodiments. In RSFQ logic, the SQUID is the basis of all traditional binary logic gates. The relevant superconducting gates depicted in FIG. 2 are described in Table 1 below:

TABLE 1
Superconducting Gates

| | |
|---|---|
| S: | Produces a pulse at both outputs per input pulse. |
| M: | Produces a pulse at the output for a pulse at either input. |
| JTL: | Acts as a buffer, sharpening the output pulse. |
| FA: | Produces an output pulse at the first time an input pulse |
| | arrives at either of its two inputs. |
| DFF: | S sets the SQUID to 1. R resets the SQUID and generates |
| | an output pulse. |
| DFF2: | A sets the SQUID to 1. C1(C2) resets the SQUID and |
| | generates an output pulse at Y1(Y2). |
| TFF2: | Distributes the incoming pulses through alternating |
| | output ports. |
| NDRO: | Ports S, R, and Q resemble a DFF. A pulse at the CLK port |
| | reads the SQUID's state without altering it. |

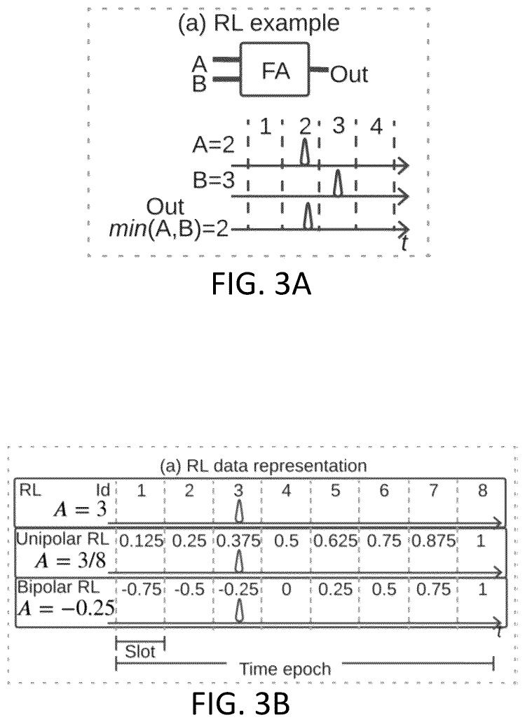

FIG. 3A illustrates an example race logic operation, according to some embodiments. Race Logic (RL) provides an alternative way of encoding and processing information using RSFQ logic. In RL, information is encoded as a delay from a reference signal. Computation is performed by observing the relative propagation times of signals injected into a circuit (i.e., the outcome of races). For example, as depicted in FIG. 3A, the computation of the minimum between two RL signals is determined by the first signal to arrive (e.g., the signal representing the number 2 arrives sooner than the signal representing 3. First arrival (FA) requires only 8 JJs, while a binary implementation of the minimum between two numbers requires more than 4K JJs. Because RL encodes data in time, it is well-suited for dynamic programming but basic arithmetic operations such as addition and multiplication are expensive in terms of area and latency.

FIG. 3B illustrates an example race logic data representation for unipolar and bipolar schemes, according to one embodiment. To understand the proposed U-SFQ data representation, embodiments begin from RL. FIG. 3B shows a typical RL epoch where an epoch is defined to be subdivided into time slots. To represent number 3, the SFQ pulse arrives at the time slot identified as Id=3. Embodiments then modify the original RL definition by dividing the time slot Id by the maximum time slot in the epoch, thus obtaining a numerical representation between 0 and 1. This unipolar data representation enables operations for positive numbers, which agrees with the natural evolution of time. Inspired by the bipolar stochastic computing representation, embodiments obtain a RL bipolar representation by scaling and shifting the unipolar Id such that Id_{b}=2Idᵤ−1, where Idᵤ is the unipolar Id and Id_{b} the equivalent bipolar Id.

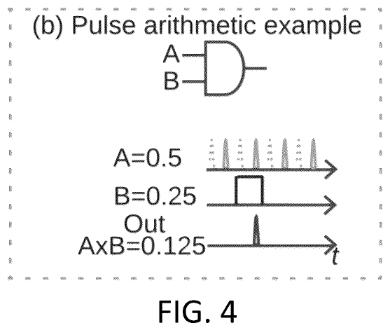

FIG. 4 illustrates an example of pulse arithmetic within a pulse stream logic scheme, according to one embodiment. In pulse stream arithmetic, a number p is mapped to the rate (Rp) of a train of voltage spikes such that Rₚ=0 for p=0, and Rₚ=Rₘₐₓ for p=1. Consequently, there is a maximum number of pulses Nₘₐₓ that occurs when p=1. Then, p is recovered from the pulse stream by counting the number of pulses and dividing them by Nₘₐₓ. Opposite to RL, pulse stream representation favors mathematical operations such as multiplication and addition. For example, multiplication is performed by filtering out a fraction of the pulses with an AND gate. For example, as depicted in FIG. 4, for pulse stream multiplication with A=0.5 represented as a stream of pulses firing at half the maximum frequency and B=0.25 represented as a CMOS level signal. The result y can be obtained by y=N_{y}/Nₘₐₓ where N_{y} is the number of pulses coming out of the AND gate.

Inspired by the natural occurrence of pulses in SFQ logic, embodiments combine pulse stream-arithmetic with RL to create a unary SFQ data representation. Embodiments alleviate SFQ area constraints via design of processing elements with a minimum area footprint while leveraging the high SFQ processing speeds.

Embodiments map a number p to the frequency Rₚ of a periodic train of SFQ pulses, inspired by pulse stream arithmetic. A unipolar data representation maps the maximum rate Rₘₐₓ, or equivalently the maximum number of pulses Nₘₐₓ in an epoch, to 1 and the absence of pulses to 0. Accordingly, p=n/Nₘₐₓ, where n is the number of pulses during a computing epoch. Also, each pulse has an associated weight of 1/Nₘₐₓ. Similar to SSC, to enable negative numbers embodiments derive a bipolar data representation as p_{b}=2pᵤ−1, where pᵤ is the unipolar representation and p_{b} is the equivalent in a bipolar representation.

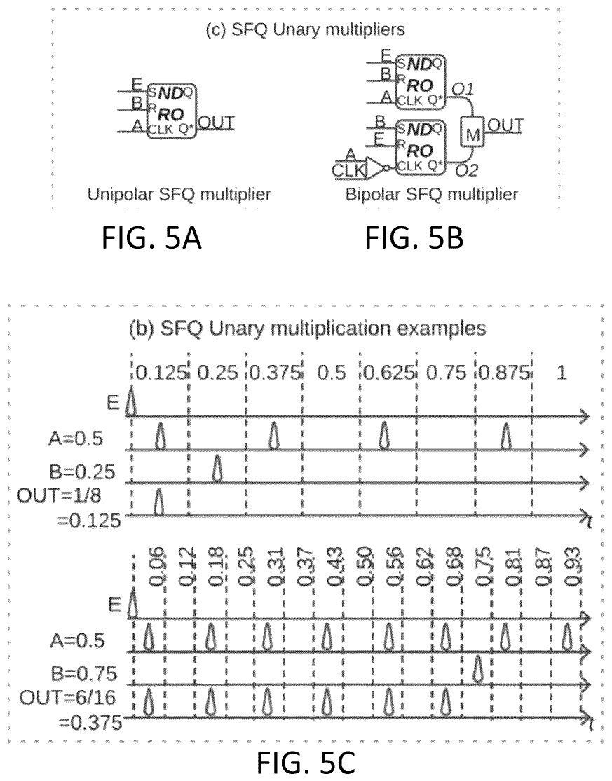

FIG. 5A-C depict an implementation of a unary SFQ multiplier, according to some embodiments. Two major architectures dominate the design of multipliers and adders in SFQ technology: a) bit parallel architecture and b) wave-pipelined architecture. In bit-parallel architectures, every cell is clocked (e.g., coupled to a clock signal that synchronized operations). The frequency of the pipeline is dictated by the maximum cell propagation time added to the cell's setup and hold times. Typically, in bit-parallel architectures, there is a significant synchronization overhead. In wave-pipelining, a calculation starts as soon as both operands arrive and advances as a flow of pulses instead of waiting for the clock. Wave-pipelining yields up to 3× better area metrics due to the absence of a clock signal per cell, yet it has a performance penalty due to the extra time required to avoid data collisions among the data waves.

Because direct mapping of CMOS-pulse stream-arithmetic building blocks to SFQ is expensive, embodiments combine pulse streams with the compactness of RL to enable efficient processing units.

FIG. 5A illustrates a unipolar SFQ multiplier, according to one embodiment. Given two numbers p_{A} and p_{B} in the range of [0, 1], embodiments encode p_{A} as the rate of an SFQ pulse stream A, and p_{B} as a RL signal B. To calculate p_{A}×p_{B}, embodiments use the RL signal B to filter out a percentage of pulses from A, as depicted in FIG. 5C. What remains after the filtering process, encoded in a pulse stream, is the multiplication result. To implement this, embodiments use an non-destructive read-out (NDRO) cell as shown in FIG. 5A. Using a single NDRO, embodiments can multiply positive numbers, referred to as unipolar multiplication.

FIG. 5B illustrates a bipolar SFQ multiplier, according to one embodiment. The bipolar multiplier may be configured to multiply negative numbers. Before the arrival of the RL pulse B, the top NDRO lets the pulse stream A pass through. As a result, O1=A∧B. When B arrives, it sets the bottom NDRO letting ¬A pass. As a result, O2=¬A∧¬B. The merger combines O1 and O2 obtaining OUT=(A∧B)∨(¬A∧¬B).

FIG. 5C illustrates two examples of SFQ unary multiplication, according to one embodiment.

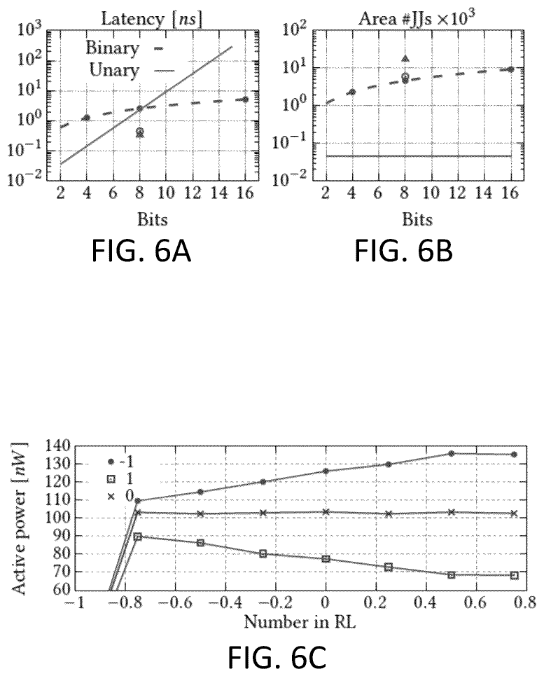

FIG. 6A illustrates a comparison of latency of a proposed SFQ unary multiplier compared to a binary multiplier, according to one embodiment. The simulated delay for our proposed multiplier is t_{INV}=9 ps, which corresponds to the propagation, setup and hold time for the inverter. This also results in maximum frequency of ≈111 GHz, which translates to a computation latency of 2Bt_{INV} with B the bit resolution. The latency of the binary multiplier is linearly proportional to B, while the latency of the unary multiplier increases exponentially with B. Compared with a BP multiplier, the binary architecture is 6× faster than U-SFQ at the expense of 370× more area for 8 bits. When compared with the WP architecture, the unary multiplier is faster for less than 8 bits.

FIG. 6B illustrates a comparison of area consumption of a proposed SFQ unary multiplier compared to a binary multiplier, according to one embodiment. The area (number of JJs) of the binary multiplier is proportional to the number of bits, while the area of the unary multiplier remains constant. Our proposed multiplier occupies 25× to 200× less area than the binary Wave-Pipelined (WP) architecture. When compared with the BP binary architecture in, the unary multiplier yields 370× savings in area.

FIG. 6C illustrates a power consumption of a proposed multiplier, according to one embodiment. Embodiments perform simulations to extract power consumption for the building blocks described above. These simulations are set such that the activity factor is the average of the best and worst case scenarios. Since embodiments combine RL and pulse streams, embodiments obtain this average when the pulse streams are set to be half the maximum frequency, and the RL encoded inputs are set to be half the computing epoch.

Power consumption in RSFQ can be divided in two components. First, active power, which is in the order of tens of nWs per gate. Second, static power produced by the resistive bias current distribution network, which is typically in the order of μWs. To evaluate the power efficiency of our circuits, embodiments simulate the proposed unipolar PE to obtain its power consumption. Without taking into account cooling costs, embodiments show that the active power consumption is 0.8 μW while the passive power is 262 μW. Embodiments also simulate the active power consumption for a 32 taps U-SFQ DPU obtaining 8.45 μW. Note that the active power consumption is three orders of magnitude smaller than CMOS (≈1 mW).

The passive power consumption can be eliminated by using the Energy-efficient RSFQ (ERSFQ) and energy-efficient-synchronous-phase-compensation SFQ (eSFQ) logic families. These logic families replace the resistive biasing network with limiting JJs and series inductances, yielding the same performance (delay), at the cost of a slight (1.4×) increment in area and design cost. Moreover, the cost of cryocooling can be bypassed for sensors, such as IR or x-ray detectors, that already operate at cryogenic temperatures.

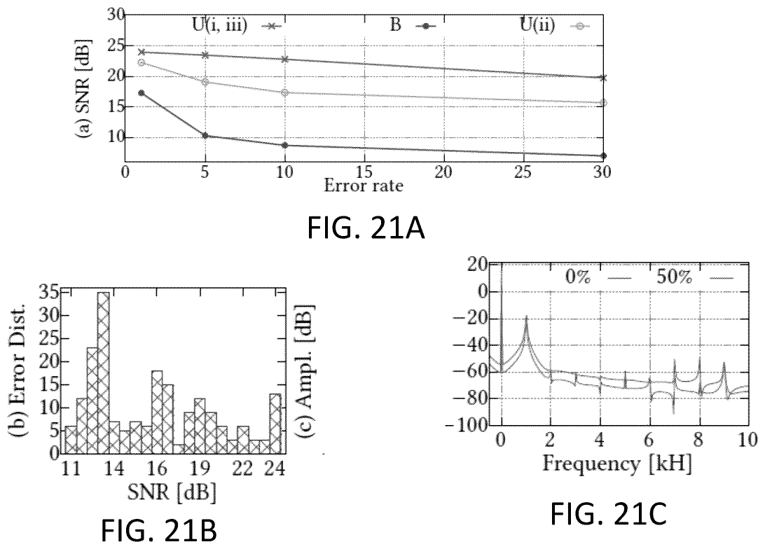

To evaluate the effect of the activity factor (α) in the active power consumption, embodiments run simulations for the bipolar multiplier varying the RL input from −1 to 1. Embodiments also vary the pulse stream frequency from −1 to 1. FIG. 21A shows the average active power consumption for minimum, maximum, and intermediate frequencies representing the numbers −1, 1 and 0 respectively. For −1 and 1 the number of pulses propagating from input to output increases and decreases respectively with the value of the RL input. This is reflected in the power consumption trends. For 0, the pulse stream frequency is set to half the maximum frequency, and the power consumption is constant because the same number of pulses propagate through the multiplier independently on the RL input. The multiplier's active power is bounded by a minimum power of 68 nW and a maximum power of 135 nW.

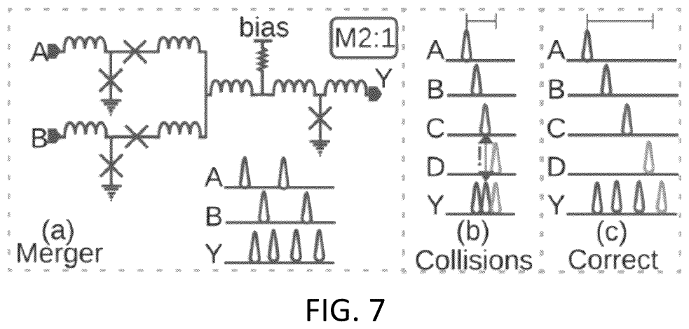

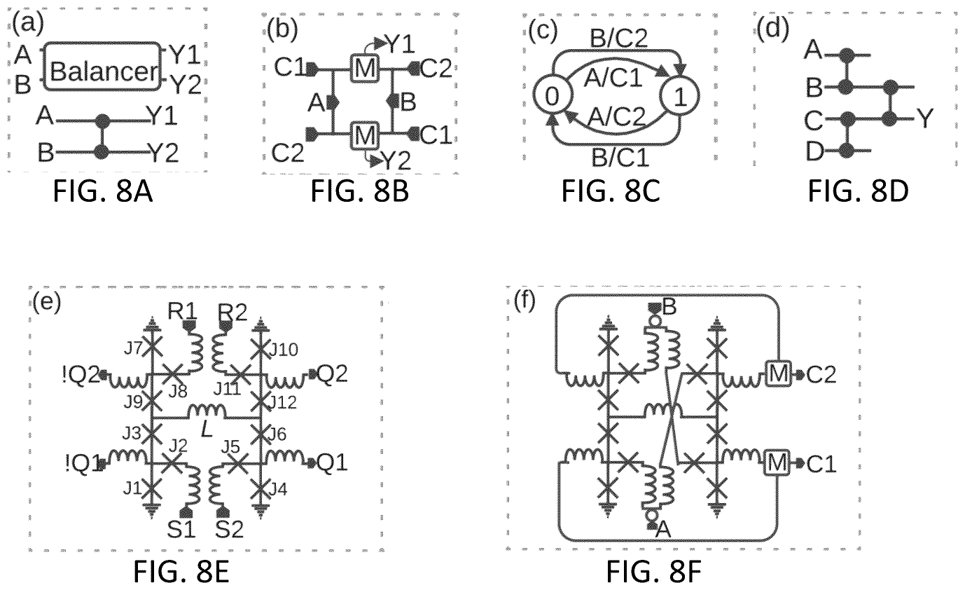

FIGS. 7 and 8A-D illustrate two possible implementations for a unary SFQ adder: (A) a merger and (B) a counting network. FIG. 7 illustrates an example circuit for a SFQ unary adder by merger, according to one embodiment. One method for addition merges pulses into a single stream. A typical 2:1 SFQ merger cell has two inputs (A, B), one output (Y), and resembles the behavior of a CMOS OR gate. The addition result p_{Y}=p_{A}+p_{B} is obtained by counting the number of pulses at the merger's output and dividing by the maximum number of pulses expected in the computation time. Computation error arises from the arrival of two pulses simultaneously at the merger input ports. In this case, only one pulse appears at the output Y. Therefore, the architecture must guarantee that pulses do not collide. This increases the minimum pulse spacing, increasing the computation latency. Moreover, the distance between input pulses is dictated by the intrinsic delay of the merger cell.

FIG. 7 shows an error example for a 4:1 merger cell (an M:1 merger cell can be built from 2:1 merger cells). As depicted, four pulses come in and only three come out. FIG. 7 also shows how to avoid collisions by increasing computation latency. The minimum distance between pulses increases with the number of inputs.

FIGS. 8A-F illustrate an M:1 counting network (M inputs, one output) where M is a power of two. Embodiments provide for an RSFQ balancer for pulse streams that is composed of two circuits: (i) an output stage (depicted in FIG. 8B) and (ii) a routing unit (depicted in FIG. 8F).

FIG. 8A illustrates an example 2:2 balancer component, according to one embodiment. A balancer is the building block for counting networks. A balancer has two inputs and two outputs, and acts like a toggle mechanism that repeatedly sends one incoming pulse to the top output and one to the bottom, balancing the number of pulses at both outputs. The advantage of the balancer over the merger is its ability to deal with collisions. When pulses appear simultaneously at inputs A and B, a pulse is generated at each output. Consequently, each balancer's output generates (N_{A}+N_{B})/2 pulses, with N_{A}, N_{B} the number of pulses at input A and B, respectively. The addition p_{Y}=(p_{A}+p_{B})/2 is obtained by counting the number of pulses at either Y1 or Y2 and dividing by Nₘₐₓ.

FIG. 8D shows an example of a 4:1 counting network built with three balancers. Since the balancer divides the number of input pulses by two, the total number of pulses at the counting network output is (N_{A1}+N_{A2}+ . . . +N_{AM})/M, with N_{A1}, N_{A2}, . . . , N_{AM} the number of pulses at the A1, A2, . . . , AM input ports. The addition result p_{Y}=(p_{A1}+p_{A2}+ . . . +p_{AM})/M is the number of pulses at the counting network output divided by Nₘₐₓ. In some embodiments, the counting network includes a M:1 counting network to accumulate pulses coming from M parallel inputs.

FIG. 8B illustrates an example balancer output stage, according to one embodiment. The output stage depicted in FIG. 8B enables the propagation of two simultaneous incoming pulses. The stage is composed of two DFF2s facing each other through merger cells. The SFQ loop for the DFF2 on the right (left) is set to “1” by input A (B). After this, control signal C1 (C2) reads the DFF2 state through the top (bottom) output. C1 and C2 are generated by the routing unit as described below.

FIG. 8C illustrates a Mealey machine of a balancer routing logic, according to one embodiment. The routing unit following the Mealey machine shown in FIG. 8C generates C1 and C2 (control signals for the balancer output of FIG. 8B). An incoming pulse from either A or B causes a toggle between states 0 and 1. Outputs C1 and C2 depend on both the state and the inputs.

FIG. 8F illustrates the routing unit which is based on the B-Flip Flop (BFF). The BFF (FIG. 8E) has four inputs that modify a single quantizing loop with two stationary states. The quantizing loop is formed by an inductance L closed via the ground and two 4-JJ-low-inductance-loops. Embodiments connect the balancer's input A (B) to S1 and R2 (S2 and R1) through splitter cells. Embodiments then merge Q1 and !Q1 (Q2 and !Q2) to generate outputs C1 (C2).

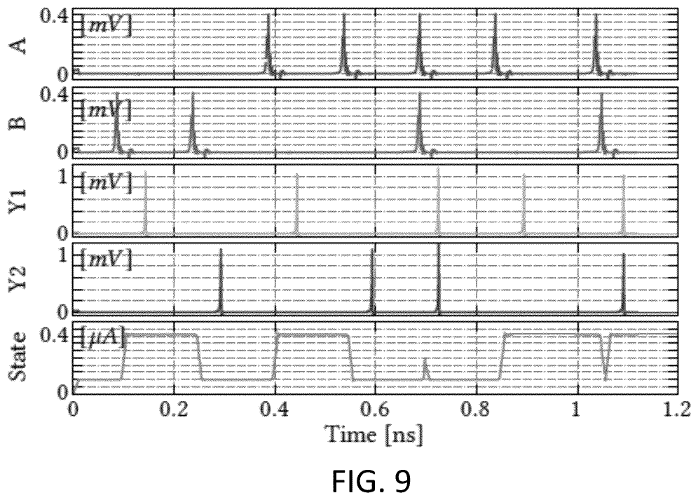

FIG. 9 illustrates example balancer input and output waveforms, according to one embodiment. The first pulse at input port B causes the state to transition from “0” to “1” (green), generating a pulse at output Y1. The next incoming pulse at either input port A or B will provoke a pulse at output Y2 and the state reset. When pulses arrive at inputs A and B simultaneously (˜7 ps), there is one pulse at each output. Each output produces a number of pulses equal to the total number of pulses coming from A plus B divided by 2.

For the BFF state sequence, three different cases can be observed: (i) Pulses at A and B arrive at different times; (ii) Pulses at A and B arrive at the same time; and (iii) A second pulse arrives when the BFF state is transitioning. For cases (i) and (ii), the behavior of the cell follows the Mealy machine in FIG. 8C. Moreover, because the output stage handles two pulses simultaneously, no additional action is needed.

Case (iii) causes unwanted behavior. If a second pulse arrives at either input during BFF transition (t_{BFF}=12 ps), this pulse is ignored by the control logic. Although the output is still correct because the output unit still generates two pulses, over time the balancer might be biased towards one output. To avoid this situation, embodiments provide a minimum delay of t_{BFF} between input pulses. Thus, the adder latency is set by t=2^{B}t_{BFF} with B the bits resolution.

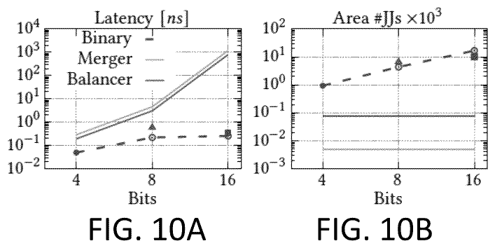

FIG. 10A illustrates a comparison of latency for unary SFQ and binary adders, according to one embodiment. FIG. 10B illustrates a comparison of area consumption for unary SFQ and binary adders, according to one embodiment. Both the merger and balancer yield area savings compared to the binary adder, but with a latency penalty. The balancer yields 11×−200× area savings versus the binary adder for 4-16 bits.

In typical DSP and neural network accelerators, inputs are multiplied with coefficients or weights. Since these coefficients are loaded in memory once and rarely get updated thereafter, they require non-destructive-read-out memory. In binary SFQ, this type of memory uses NDROs. Thus, the next challenge is to generate these SFQ pulse streams to encode the coefficients and weights in U-SFQ.

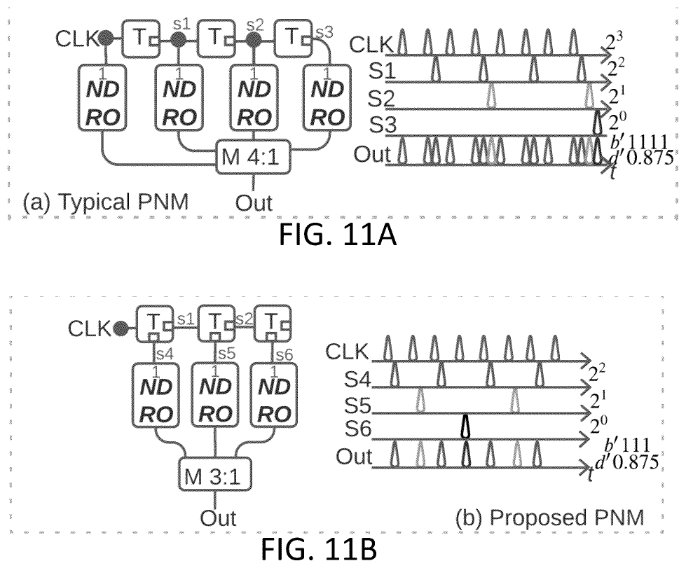

To generate the pulse streams, embodiments adopt a Pulse Number Multiplier (PNM) that creates a high-speed pulse train from a low-frequency input. FIG. 11A shows the circuit and timing diagram for a typical PNM where a clock signal (CLK) is divided by a chain of TFFs. The output of each TFF is merged to generate the pulse stream. The number of pulses is programmable and set by the NDROs that each acts as an AND gate. FIG. 11A shows the pulse stream (out) with the NDROs set to “1111”, which yields 15 pulses. If instead the NDROs were set to “0100”, the result is four pulses (S1).

FIG. 11B a pulse number multiplier (PNM) using TFF2s to generate a stream resembling a uniform rate, according to one embodiment. The pulses generated by the PNM of FIG. 11A are not uniformly spaced, to the detriment of computation accuracy. Recall that the pulses must appear at a regular frequency. To address this issue, embodiments include a dual-port Toggle-flip-flop (TFF2), which works like a demultiplexer, splitting up a data stream into two signal lines. One of the outputs of the TFF2 is used to divide the clock by half, while the other is used to form the pulse stream. The resulting pulse stream resembles a train of pulses with a uniform rate.

Similar to an SFQ binary implementation, the NDROs in FIG. 11B are the memory bank. To obtain pulse streams from this memory bank, embodiments use the proposed PNM to generate the clock for the NDROs and mergers to form the pulse streams. The mergers and clock distribution network cost a 10% area overhead compared to a binary implementation. Another important piece to complete a U-SFQ accelerator is a shift register to enable an efficient memory implementation. In a typical binary implementation, the shift register is a bank of DFFs. Embodiments include at least three example implementations of a shift register for RL: (i) a combination of a binary shift register with binary-to-RL conversion; (ii) a DFF-based shift register for RL; and (iii) an integrator-based shift register for RL. A straightforward implementation connects the binary bank of DFFs with binary-to-RLconverters (B2RC). B2RCs are programmable counters designed as an interleaved chain of TFFs and DFFs.

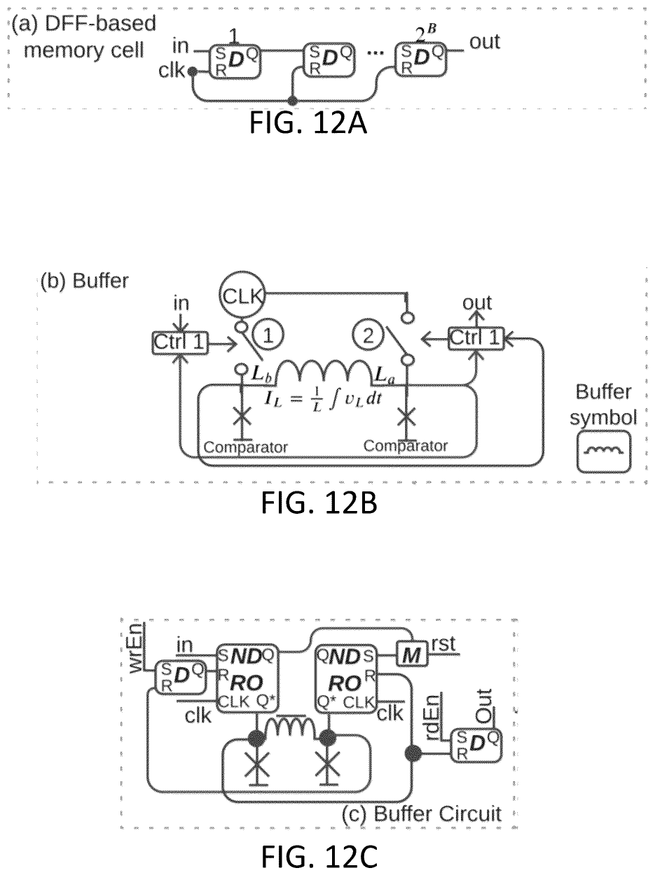

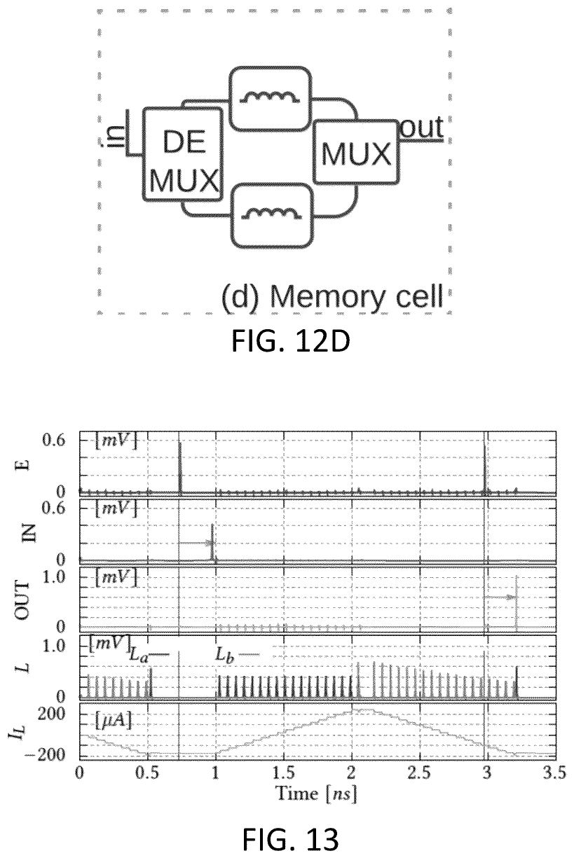

FIG. 12A illustrates a race logic shift register using SFQ DFFs, according to one embodiment. To avoid expensive binary to race logic converters (B2RCs), the shift register includes inputs and outputs encoded in RL. This can be achieved by connecting DFFs in series to create a delay chain controlled by a clock. To delay a pulse by the total number of time-slots in an epoch, a DFF per time-slot is required. Since the number of DFFs grows exponentially with the number of bits, this solution is more expensive than using B2RCs.

FIG. 12B illustrates an example of a conceptual integrator-based race logic buffer using an inductance to accumulate SFQ pulses, according to one embodiment. Embodiments include an integrator-based buffer for RL. For example, embodiments use an inductor to integrate pulses from a clock source given the inductor's current-voltage relation I_{L}=1/L∫vLdt. The RL input pulse initiates the integration. One epoch later, the integration stops and generates the RL output.

In more detail, the arrival of a RL input (in) closes switch (1), starting the integration. The integration pauses when J1, which acts as a comparator, reaches its critical current Ic. The time it takes for J1 to kickback is equivalent to half an epoch. Then, the circuit starts to discharge the inductor by activating switch (2) until it reaches a low baseline. At that time, J2 kicks-back generating the output pulse (out). The process of charging and discharging the inductor delays the input signal by a complete epoch.

FIG. 12C shows the SFQ circuit for the proposed buffer. The NDROs are switches (1) and (2), while the DFFs take only the first pulse observed at the inductor ends Lₐ and L_{b}.

FIG. 12D A memory cell uses two buffers in parallel. While one buffer is delaying the input from the previous epoch, the other one receives the input from the current epoch. To interleave the two buffers, embodiments use an RSFQ multiplexer and de-multiplexer as shown in FIG. 12D. The complete RL shift register is built by connecting memory cells in series.

FIG. 13 shows the simulation waveforms for the buffer. E signals the beginning of a new epoch. The RL input pulse (IN) carries information in the time delay measured from the beginning of the epoch. The output pulse (OUT) appears with the same delay at the next epoch. Signals Lₐ and L_{b} are voltages at the inductor endpoints. IL is the current in the inductor.

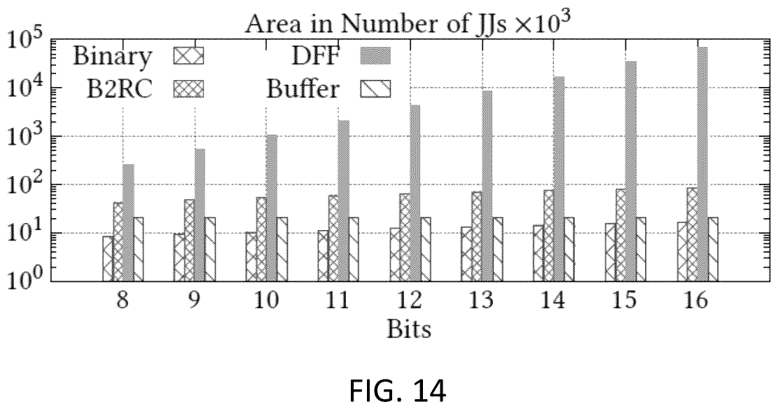

FIG. 14 shows the area in JJs for the shift register built using our proposed buffer. In contrast to other implementations, the number of JJs for the buffer is constant while the inductance value increases with the number of bits. Our preliminary simulations show that the inductance increment is negligible compared with the JJ count of the other implementations. The inductor value L, the frequency of the clock, and the JJ's Ic depend on the bit resolution and epoch time. All in all, the integrator-based shift register is smaller than B2RCs and the DFF-based RL options, yet it yields an area overhead compared to a binary shift register. For 8 bits, the area overhead is 2.5× but only 1.3× for 16 bits. FIG. 14 shows that this takes up to 3.2× more area than its binary counterpart due to the expensive converters.

Embodiments include implementations of three hardware accelerators using the above U-SFQ building blocks, including: (i) A processing element (PE) suitable for CGRAs or spatial architectures, (ii) A DPU, popular in DSP and NN accelerators, and (iii) An FIR accelerator.

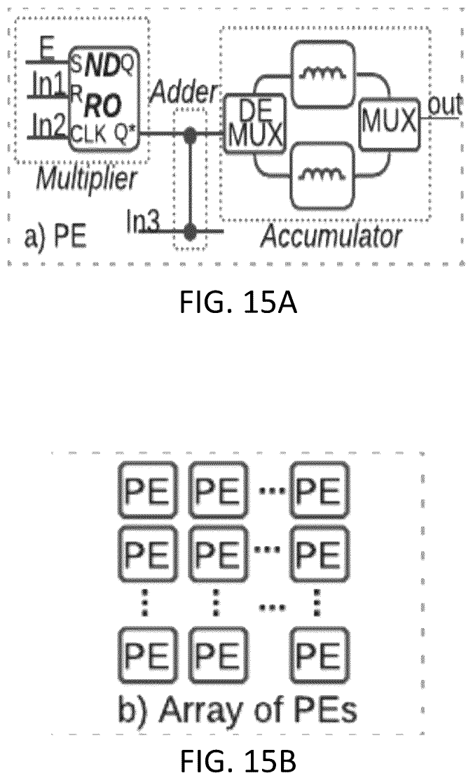

FIG. 15A illustrates an example of a unipolar processing element consisting of a multiplier, adder, and integrator, according to one embodiment. The Processing Element (PE) is the core of popular hardware accelerators such as CGRAs and SpA for convolutional neural networks (CNNs). Suitable kernels mainly perform repetitive operations, such as multiply accumulate (MAC) and arithmetic operations. With the computing elements introduced above embodiments provide for a unipolar PE for CGRAs or SpAs, as shown in FIG. 15A. The proposed PE can perform the following mathematical operations: unipolar multiplication with In1 a RL input and In2 a pulse stream, unipolar addition among In2 and In3 using the balancer described above with respect to FIG. 8A and setting In1 to 1, and a multiply-accumulation operation using the integrator described with respect to FIGS. 12A-C. The integrator performs two tasks. First, each pulse from the adder is integrated in the analog buffer (accumulation). Second, the accumulated result is returned in a RL format facilitating the interface among PEs. The U-SFQ PE yields significant area savings when compared with its B-SFQ counterpart. The number of JJs for the U-SFQ PE is 126 and does not increase with the number of bits. On the other hand, the number of JJs for the binary PE increases linearly with the number of bits. As an example, the U-SFQ yields 98%-99% savings in area when compared with an 8-bits B-SFQ PE that requires 9K-17 k JJs.

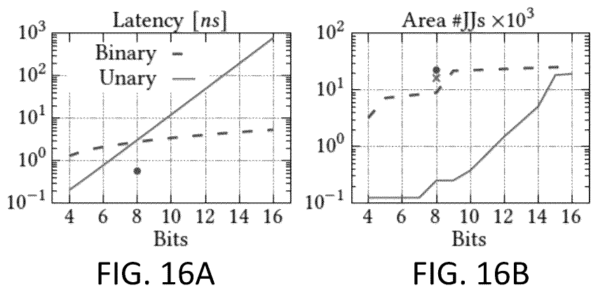

FIG. 15B illustrates an example of an array of processing elements in a hardware accelerator, according to one embodiment. The U-SFQ PE enables the integration of multiple PEs at a reduced area cost, thus increasing overall throughput. The minimum footprint of the U-SFQ PE comes at an increased latency. FIG. 16A shows that in general the binary implementation yields better latency for an individual PE. Accordingly, to match latency of the binary SFQ, embodiments provide an array of PEs. As depicted in FIG. 16B, an array of U-SFQ PEs matching the latency of binary SFQ yields 93%-96% savings in area when compared with the Wave-Pipelined (WP) binary architecture for less than 12 bits. As the resolution increases the area savings reduce up to 30% for 16 bits. When compared with an 8-bit bit-parallel architecture there are area savings of 28%.

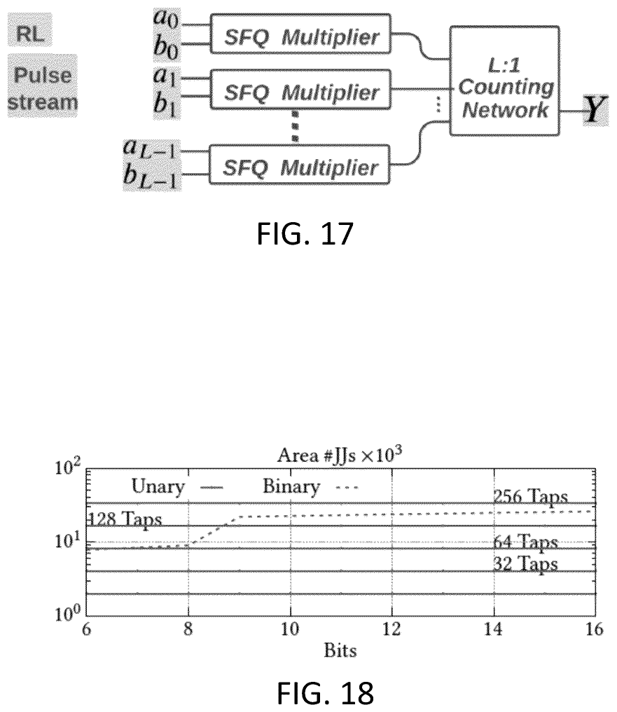

FIG. 17 illustrates an example unary SFQ dot product unit, according to one embodiment. The dot-product is the building block for several DSP algorithms and for artificial neural networks. Moreover, the dot-product is one of the most computationally expensive operations given the high number of multiplications required to obtain a result. These properties make the dot-product a good benchmark for a unary SFQ data representation. The dot product between vectors a and b of length L is defined as y=a·b=Σᵢ₌₀^{L-1}a[i]b[i] where the result y is a scalar.

A straightforward mapping of the dot-product equation requires as many multipliers and adders as the input length L. Unfortunately, due to poor JJ device density, the number of binary multipliers and adders that can be practically deployed is restricted to 1-4, especially for many bits. Embodiments leveraging the small footprint of the U-SFQ multiplier and adder described above to instantiate a larger number of multipliers and adders in parallel to implement a DPU. As depicted in FIG. 16, the U-SFQ multiplier receives inputs a₀, . . . a_{L} in RL format while inputs b₀, . . . , b_{L} are pulse streams. The counting network receives parallel pulse streams and combines them such that

$$Y = \frac{{a}_{0} {b}_{0} + {a}_{1} {b}_{1} + … {a}_{L} {b}_{L}}{L} .$$

FIG. 18 compares the area in number of JJs for the U-SFQ and SFQ binary implementations. The U-SFQ DPU area is independent of the number of bits and is proportional to the vector length L, while the binary DPU is proportional to both the number of bits and the vector length. The unary implementation yields area savings for L less than 64. For L=128, both architectures become comparable and the area depends on the number of bits. For example, a unary DPU for a vector length of 128 yields area savings for a resolution of more than 12 bits. Finally, beyond 256 taps, the parallel multipliers and adders complexity increases beyond a single binary multiply accumulation unit.

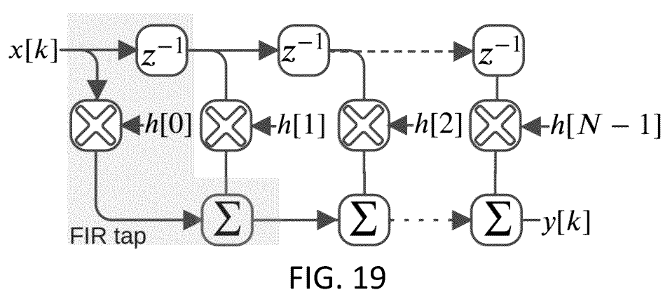

FIG. 19 illustrates an example of a unary SFQ finite impulse response filter (FIR), according to some embodiments. Because of their stable and linear-phase response, FIR filters have widespread use in digital communication, image processing, and signal preconditioning. The output y[n] of the FIR filter of order N is the dot product between the filter's impulse response h(k) with the input vector x(n−k) defined as y[n]=Σₖ₌₀^{N-1}h(k)x(n−k).

A FIR architecture has N taps. A tap consists of a multiplier, an adder, and a delay element z−1. FIR filters are computationally intensive given the large number of multiplications. For example, Infra-Red (IR) sensors require 30 taps with 6-8 bits of resolution, while Software-Defined-Radio (SDR) requires 200-900 taps and 7-14 bits of resolution.

To implement a FIR tap embodiments may use the DPU unit, described with respect to FIG. 17, for multiplication and addition and the RL shift register described in FIGS. 12A-C to implement the delay element z−1. To store the coefficients h[i], embodiments may use the memory bank described with respect to FIG. 11B. In practice, the format of external inputs and therefore any necessary conversions depends on the application. For instance, sensors could directly generate temporal inputs. For the FIR output, embodiments may include an SFQ pulse counter to convert to binary representation. However, the circuit after the FIR may expect pulse streams (no need to convert) or RL. In the latter case, embodiments may include the integrator described with respect to FIGS. 12A-C to convert pulse streams to RL. In that case, the FIR latency is not affected and area increases by 50-200 JJs. Embodiments of the FIR architecture using the U-SFQ units yields throughput and area advantages depending on the number of taps and bits resolution.

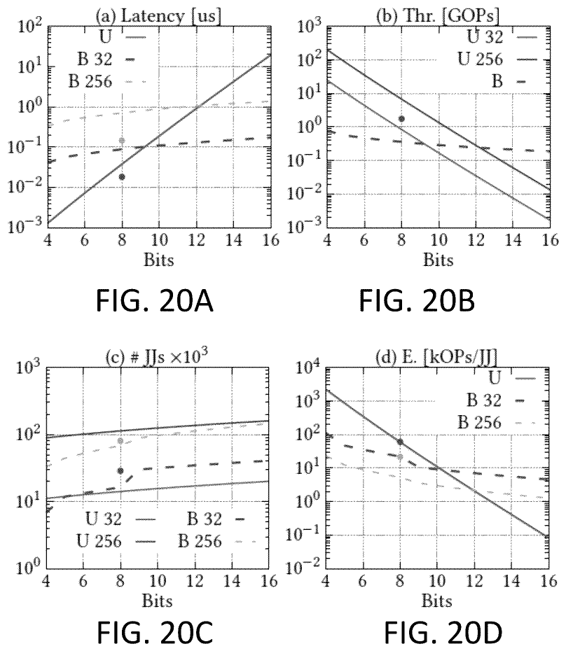

FIG. 20A-B illustrates a comparison of latency and throughput for a unary SFQ and binary SFQ finite impulse response filter, according to some embodiments. In the depicted Figures, the comparison is for 32 and 256 taps. The latency for the unary implementation is independent of the number of taps. Also, it yields latency and throughput advantages for less than 9 (12) bits with 32 (256) taps when compared with WP binary architectures. This range covers many on-sensor and edge computing applications, which is an area of increasing interest. Previous work in CNNs demonstrated that fixed-point arithmetic with as low as 4 bits yields acceptable accuracy. The U-SFQ FIR yields better performance than the BP binary counterpart for 256-taps but not for 32-taps. This is because in the U-SFQ FIR the performance is set by the memory elements instead of the computing elements. The delay for the U-SFQ multiplier(adder) is 9 ps(12 ps) versus a PNM's delay of 20 ps.

The latency for the U-SFQ FIR is set by the PNM described above. The period of the low-frequency clock used by the PNM is given by T_{CLK}=t_{TFF2}B, where t_{TFF2}=20 ps is the delay of the TFF2 and B is the resolution in bits. Then, the total computation latency is t=2BT CLK.

FIG. 20C illustrates a comparison of area consumption for a unary SFQ and binary SFQ finite impulse response filter, according to some embodiments. FIG. 20D illustrates a comparison of efficiency for a unary SFQ and binary SFQ finite impulse response filter, according to some embodiments. Embodiments may use throughput per JJ as a metric of efficiency. FIG. 20D compares the efficiency of the binary and unary architectures for 32 and 256 taps.

FIG. 21A illustrates a signal to noise ratio against an error rate for a unary SFQ finite impulse response filter, according to some embodiments. Simulations evaluating the U-SFQ FIR accelerator response in the presence of errors, may generate a golden reference that includes an input x(t), the filter impulse response h(t), and the filter output y(t). The synthetic input x(t) may be a superposition of sinusoidal signals with frequencies at 1 KHz, 7 KHz, 8 KHz, and 9 KHz. A 16-taps FIR filter may be designed to recover the 1 KHz sine wave from x(t) and filter out the remaining higher frequency waves and inputs may be scaled to avoid overflow errors. The Signal-to-Noise-Ratio (SNR) of the sinusoidal obtained at the FIR filter output y(t) is 25.7 dBs. In some examples, models may be built for fixed-point binary and U-SFQ FIR filters. As expected, both the unary and binary architectures suffer an SNR degradation due to quantization noise. For instance, for 16 bits, the calculated SNR is 24dBs and for 6 bits is 15dBs. By randomly injecting errors in the computation results, the SNR can be determined for various error rates. For binary, an error typically results in bits flipped, causing the SNR to drop quickly as the number of errors increases i.e., three errors cause the SNR to drop ˜10 dBs in average. The large SNR variance shows that the error can be catastrophic when the most significant bits flip.

Three possible errors can affect the U-SFQ FIR filter: (i) Lost pulses in pulse streams: A pulse can get lost due to non-ideal circuit behavior, i.e., flux trapped in parasitic inductors, or delay variations causing pulse collisions in the adder. (ii) Lost pulses in RL: Similarly, the RL pulse can be lost due to the aforementioned non-idealities of the circuit. (iii) Delayed pulses in RL: Either positive or negative delay variations cause the RL pulses to arrive outside the expected time-slot, modifying the value of the RL operand.

The effect of errors (i) and (iii) on the computation accuracy is similar. In contrast to a binary representation, each pulse in a pulse stream has the same weight ½B where B is the bit resolution. FIG. 21A shows that when the SNR for the binary implementation drops by 10 dBs on average, the SNR for the U-SFQ filter only drops 4 dB.

For a binary implementation, the effect of the error depends on the bit weight as shown by the large distribution of SNR shown in FIG. 20B. In the unary implementation, for B=16, there are 2B pulses in the stream, and each pulse weights 0.0000152. Thus, missing 30% of the pulses causes an SNR degradation of only 4dBs. A delay of ±30% in the RL input has a similar effect due to its interaction with the pulse stream. As discussed above, the adder returns the total number of pulses divided by two. When the number of pulses is odd, the result yields an error of ±0.5. Our model includes this effect in the accuracy evaluation.

FIG. 21A also shows the effect of error (ii). A lost RL pulse has a larger effect on computation accuracy because all the information is concentrated in a single pulse. Given the low density of RL pulses in the FIR datapath, collisions are unlikely, in contrast to pulse streams. Special care should be taken during the layout of the RL lanes to avoid non-ideal effects such as unintentional flux trapped in parasitic inductors. FIG. 21C illustrates the effect of errors in the frequency response for a unary SFQ finite impulse response filter, according to some embodiments.

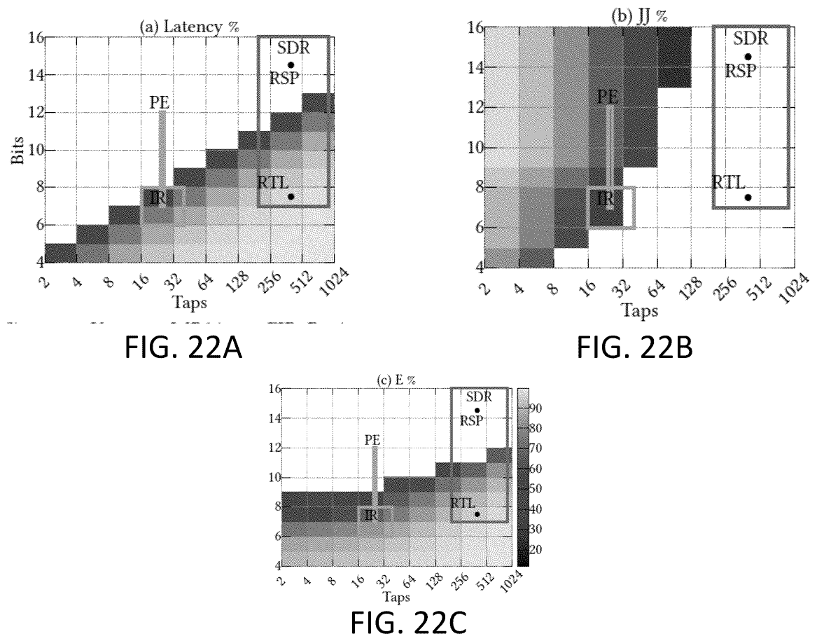

FIG. 22A illustrates a percentage improvement in latency for a unary SFQ finite impulse response filter over a WP binary finite impulse response filter, according to some embodiments. The x-axis is the number of taps, the y-axis is the number of bits, and the z-axis shows in color the percentage of latency savings offered by the U-SFQ FIR accelerator. The binary architecture performs better in areas depicted in white. For example, an 8-bit, 32-taps U-SFQ FIR yields 56% of latency savings compared to its binary counterpart, yet increasing the resolution beyond 8 bits causes a latency penalty.

FIG. 22B illustrates a percentage improvement in area consumption for a unary SFQ finite impulse response filter over a WP binary finite impulse response filter, according to some embodiments. FIG. 22B shows in color where the unary architecture yields area savings and in white where the binary architecture performs better. For 32 taps, the minimum number of bits that yields area savings is 9, while for 256 taps, the unary implementation always requires more area due to the parallel adders and multipliers.

FIG. 22C illustrates a percentage improvement in efficiency for a unary SFQ finite impulse response filter over a WP binary finite impulse response filter, according to some embodiments. As before, FIG. 22C shows where the U-SFQ FIR yields better efficiency than the WP binary counterpart. The U-SFQ FIR is more efficient for less than 12 bits. Moreover, the efficiency increases with the number of taps.

In FIGS. 22A-C embodiments highlight the design region of interest for two applications: SDR and IR sensors. Inside the SDR region, two commercial SDR cards are depicted as reference points. For an FIR that fits the RTL-2832U card, the area of a unary implementation is 60% larger. However, it yields 80% better efficiency than its binary counterpart due to 90% lower latency. For IR sensors, the U-SFQ FIR accelerator yields 13%-78% savings in latency, 40% savings in area, and overall better efficiency of 62%-89% compared with the SFQ binary accelerator.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although operations may be described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A superconducting computing architecture, comprising:
a first computing element comprising:
a first input to receive a first set of electrical pulses encoded in a first data representation;
a second input to receive a second set of electrical pulses encoded in a second data representation; and
an operator to perform an operation and generate an output based on the first set of electrical pulse of the first input and the second set of electrical pulses of the second input.

2. The superconducting computing architecture of claim 1, wherein the first computing element comprises a unary multiplier, and wherein the first data representation comprises a pulse rate of a single flux quantum (SFQ) pulse stream and the second data representation comprises a temporal Race Logic signal.

3. The superconducting computing architecture of claim 1, wherein the first computing element comprises a unary adder using merger, wherein the first data representation and the second data representation each comprise a pulse rate of an SFQ pulse stream.

4. The superconducting computing architecture of claim 1, wherein the first computing element comprises a unary adder using at least one balancer, wherein the first data representation and the second data representation each comprise a pulse rate of an SFQ pulse stream.

5. The superconducting computing architecture of claim 1, wherein the first computing element comprises a memory bank implemented as a pulse number multiplier using dual-port toggle flip flops.

6. The superconducting computing architecture of claim 1, wherein the first computing element comprises a Race Logic shift register implemented using at least one inductor to integrate pulses from a clock source.

7. The superconducting computing architecture of claim 1, further comprising a processing element comprising at least the first computing element.

8. The superconducting computing architecture of claim 7, wherein the processing element comprises at least one of a unary multiplier, a unary adder, and an accumulator implemented using the first data representation or the second data representation.

9. The superconducting computing architecture of claim 7, further comprising:
a plurality of processing elements arranged in an array of processing elements.

10. The superconducting computing architecture of claim 1, further comprising a dot product unit comprising at least the first computing element.

11. The superconducting computing architecture of claim 10, wherein the dot product unit comprises a plurality of unary multipliers arranged in parallel and a counting network.

12. The superconducting computing architecture of claim 1, further comprising a finite impulse response filter comprising at least the first computing element.

13. The superconducting computing architecture of claim 12, wherein the finite impulse response filter comprises at least one of a unary dot product unit, a unary adder, or a unary shift register to operate as a delay element.

14. A superconducting hardware accelerator circuit comprising:
a first computing element comprising:
a first input to receive a first set of electrical pulses encoded in a first data representation;
a second input to receive a second set of electrical pulses encoded in a second data representation; and
an operator to perform an operation and generate an output based on the first set of electrical pulses of the first input and the second set of electrical pulses of the second input.

15. The superconducting hardware accelerator circuit of claim 14, wherein the first computing element comprises at least one of a unary multiplier, a unary adder, a unary pulse number multiplier, or a unary shift register.

16. The superconducting hardware accelerator circuit of claim 14, further comprising a processing element comprising at least the first computing element.

17. The superconducting hardware accelerator circuit of claim 16, wherein the processing element comprises at least one of a unary multiplier, a unary adder, or an accumulator implemented using the first data representation and the second data representation.

18. The superconducting hardware accelerator circuit of claim 16, further comprising:
a plurality of processing elements arranged in an array of processing elements.

19. The superconducting hardware accelerator circuit of claim 14, further comprising a dot product unit comprising at least the first computing element, wherein the dot product unit comprises a plurality of unary multipliers arranged in parallel and a counting network.

20. The superconducting hardware accelerator circuit of claim 14, further comprising a finite impulse response filter comprising at least the first computing element, wherein the finite impulse response filter comprises at least one of a unary dot product unit, a unary adder, or a unary shift register to operate as a delay element.
